(19) United States
(12) Patent Application Publication
(10) Pub. No.: US 2006/0265310 A1
(43) Pub. Date: Nov. 23, 2006

(54) Realtime transparent commodity index and trading database

(76) Inventors: Ehud Cohen, Tel Aviv (IL); Tamar Katzav, Givat Ada (IL); Gil Galanti, Kfar Neter (IL)

Correspondence Address: ROBERT C. KAIN, JR., 750 SOUTHEAST THIRD AVENUE, SUITE 100, FT LAUDERDALE, FL, 333161153, US

(21) Appl. No.: 11/134,039

(22) Filed: May 21, 2005

(51) Int. Cl. G06Q 40/00

(52) U.S. Cl. 705/37

(57) ABSTRACT

The computerized method creates, maintains and displays realtime indexes and a trading database for diamonds or other commodities. The method maintains, on a periodic trading basis, and displays upon command, a computerized database representing diamonds available for sale. Data is processed from the database for a plurality of predetermined stone profiles grouped into statistically significant segments. The stone profiles are statistically relevant to the corresponding segment and to the entire market represented by the commodity database. Sub-indexes or segments are displayed in addition to constituent stone profiles. Trend indicators, historical data and buyer and seller data is also displayed. A member database shows all contact data for each buyer and seller and the system may include a communications routine to facilitate sales.

The present invention relates to a realtime, transparent, commodity index and trading database particularly related to indexes and a trading database for diamonds presently available for sale.

### BACKGROUND OF THE INVENTION

Historically, information relative to the diamond trade has been generally restricted to those with personally relationships in the channel of trade. In other words, the free flow of information regarding the prices for diamonds for sale was restricted to certain manufacturers or producers, their first tier wholesalers, and between first and second tier wholesalers and finally to retailers. Personal relationships between the parties dictated the amount of information available.

With the advent of the Internet, the profit margins of wholesalers and retailers have declined because first tier wholesalers have posted data relative to the sale of diamonds on the Internet. These listings include prices and descriptions of the diamonds, that is, a list of common characteristics of the diamonds for sale. Further, due to the well established grading system for diamonds, that is, color, carat (weight), cut and clarity (the cccc), diamonds have been the subject of published price lists for many years. The Rapaport Diamond Report is an example of such a published list. However, these published lists oftentimes do not reflect the actual marketplace supply and demand for the diamonds. Particularly with respect to the Rapaport Diamond Report, since Rapaport sells diamonds, it is in their best interest to either restrict information or change information in their published report to further their commercial interests. Additionally, it is well established in the diamond trade that everyone, except poorly informed consumers, receives a discount from the price reported in the Rapaport Report.

With the widespread use of the Internet and the use of trusted parties to handle, gather, compile and process complex compilations of data, there is a need to facilitate the trade of diamonds (or commodities in general) and a need for a transparent, realtime trading platform. Further, statistical analysis of large databases of diamonds (or other commodities), maybe processed to generate useful marketing information.

### OBJECTS OF THE INVENTION

It is an object of the present invention to provide a realtime, transparent, commodity index and trading database for diamonds and potentially other types of commodities.

It is a further object of the present invention to provide a realtime, transparent, diamond commodity composite index and a plurality of sub-indexes wherein the sub-indexes reflect statistically predictive components incorporated in the composite index.

It is a further object of the present invention to display to both the buyer and seller (subject to password control) the complete diamond database, the composite index, each sub-index and all constituent data relative to the composite and the sub-indexes. This transparency and the realtime nature of the database which only lists diamonds available for sale reduces the barriers to trade which arise due to the lack of accurate, current, buy-sell or supply and demand information.

Another object of the present invention is to provide sub-indexes which are statistically significant to the price of all diamonds currently available for sale based upon the respective quantity of diamond records in the database and in the sub-indexes or segment as represented by a plurality of predetermined stone profiles and their respective monetary values relative to the segment or entire database.

It is another object of the present invention to provide a computerized method and an information processing system which facilitates the communication between the buyer and seller and facilitates the sale of buyer selected diamonds in the diamond database.

It is a further object of the present invention to utilize an instant messenger service and a web based Internet server computer to provide wide dissemination of information with nominal restrictions for buyers and sellers who participate and are fully identified in the trading database with a comprehensive, transparent, contact database.

It is a further object of the present invention to provide an application service provider (ASP) computerized method and information processing system which implements the realtime, transparent trading database.

It is an additional object of the present invention to provide a facility for the sellers of diamonds to data mine the diamond database, the composite index and the sub-indexes and integrate the resultant data into a forward looking inventory control system for sophisticated sellers.

It is another object of the present invention to provide for a facility for members to sell diamonds selected by a buyer with a communications link between a financial escrow agent, a diamond courier, the willing buyer and a seller of the selected diamond.

### SUMMARY OF THE INVENTION

The computerized method creates, maintains and displays realtime indexes and a trading database for diamonds or other commodities. The method maintains, on a periodic trading basis, and displays upon command, a computerized database representing diamonds available for sale. The database also includes data representing common characteristics of each diamond or commodity. Data is processed from the database from predetermined stone profiles which are statistically significant to the entire database and to the corresponding segments. Each segment is represented by a plurality of predetermined stone profiles. Each stone profile has a common set of common characteristics. Sometimes the common set is a range of characteristics. The statistical significance of the segment to the entire database is based upon the respective quantity of diamond records in the segment and the respective monetary value of the stone profiles in relation to the entire database. Sub-indexes or segments are determined and displayed as are the constituent plurality of predetermined respective stone profiles in each segment or sub-index which are statistically significant relative to the corresponding segment and the entire database. The diamond database, each diamond record (showing only diamonds available for sale and characteristics thereof), the composite index and each sub-index as well as particulars regarding all stone profiles for each sub-index, and, in an advanced system, trend indicators showing historical trends for each sub-index and the master composite are displayed, in realtime, to buyers and sellers accessing the trading database. Preferably, a web based system is implemented and the processing and displaying is provided by a server on the Internet or other communications network (an ASP model). To facilitate the sale, in addition to the transparent presentation of data to both the buyer and the seller, the system provides a communications facility and a contact database listing each buyer and seller. Therefore, buyers and sellers can view the background information for each other prior to or concurrent with the sale. An instant messaging service or other communications protocol and linking channel may also be incorporated into the system. Data mining by certain sellers enable those sellers to integrate resultant data from the composite index, the sub-indexes and the diamond database into an inventory control system wherein the seller limits or expands his or her supply of cut and polished diamonds to the diamond market. To further stimulate the trade of diamonds, the system may include a communications link between a financial escrow agent and a diamond courier such that a willing buyer and a willing seller of a selected diamond from the database can communicate and contract with the escrow agent and the courier to hold the money and deliver the product.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates various aspects of the computerized method and information processing system showing the realtime transparent commodity index and trading database;

FIG. 2 diagrammatically illustrates a general flowchart of a computer program showing elements of the inventive computerized method or information processing system in accordance with the principles of the present invention;

FIGS. 3A-3E diagrammatically show examples of the composite index and sub-index displays as a diamond composite index and diamond drivers or sub-indexes (FIG. 3A), one type of stone profile listing for certain sub-indexes (FIG. 3B), an example of 15 diamond drivers or sub-indexes (FIG. 3C), specific data displays for a sub-index and a historical trend displays (FIG. 3D), and the statistical relevance of certain data in a pie chart form (FIG. 3E);

FIG. 4 diagrammatically illustrates a generic commodity composite index and components of the index or sub-indexes which is typically displayed to buyers and sellers;

FIGS. 5A and 5B diagrammatically illustrate an example of a diamond database list resulting from a search inquiry and a diamond record of a select diamond available for sale from the diamond database; and

FIG. 6 diagrammatically illustrates the implementation of the system on the Internet as a realtime database system utilizing a server and a plurality of client computers wherein the client computers are associated with buyers and sellers or manufacturers of the commodity or diamonds.

### DETAILED DESCRIPTION OF THE PREFERRED EMBODIMENTS

The present invention relates to a computerized method and an information processing system for a realtime, transparent database for a commodity (particularly diamonds), the production and display of a composite index and several sub-indexes. The information facilitates sales of diamonds.

The present invention is operable in conjunction with several personal computers (PC), on a computer network (LAN or WAN) or over the Internet and computer programs, computer modules and information processing systems which accomplish the electronic processing system. In addition to the computer implementation of the inventive aspects of this invention, several business methods are also encompassed herein.

It is important to know that the embodiments illustrated herein and described herein below are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The term database means all types of data structures whether in flat form, such as a spread sheet, or other forms (such as a matrix of data), such that groups of data, associated with a single item, such as a diamond, are organized into fields or sub-groups such that the group or record for a single diamond can be easily compared or sorted or processed by association to similar sub groups for other diamond records.

In the drawings, and sometimes in the specification, reference is made to certain abbreviations. The following Abbreviations Table provides a correspondence between the abbreviations and the item or feature.

Abbreviations Table

| | |
|---|---|
| Admin | administration |
| ASP | application service provider - server on a network |
| bd | board |
| C-C | common characteristic, may be a range, e.g., color D-E |
| cert | certificate generally recognized as describing the |
| | characteristics of a certain diamond |
| comm. | communications, typically telecommunications |
| comp | computer |
| CPU | central processing unit |
| DB | database |
| D detail | detail records of particular diamond |
| D sch | diamond search |
| displ | display |
| doc | document |
| IM | instant messenger communications system or function |
| I/O | input/output |
| id | identify |
| ind | trend indicator, usually an up or down arrow |
| invt | inventory available for trading or selling |
| Mbr | member, a seller-Mfr or a buyer, such as Mbr DB |
| mem | memory |
| Mfr | producer or manufacturer of cut and polished stones |
| mgt | management, such as invt mgt pgm |
| mkt | market |
| ntwk | network as in “comm ntwk” - a communications network |
| pgm | program |
| PO | printed out document |
| ppu | price per unit, usually $ per carat |
| rcd | record, such as a record in a DB |
| req | request |
| rpt | report |
| sch | search (“D sch” is diamond search) |
| sys | system |
| t | time |
| term | terminal or computer or computer workstation |
| tele-com | telecommunications system or network |
| URL | Uniform Resource Locator, x pointer, or other network |
| | locator |
| Wse | Wholesaler of diamonds or commodities |

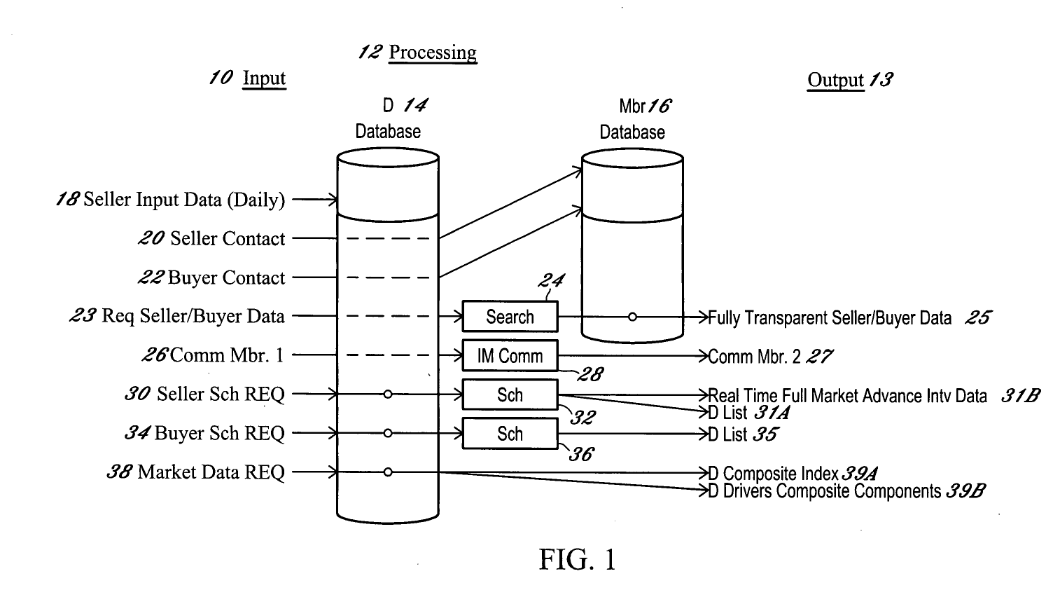

FIG. 1 shows, in diagrammatic form, several significant features of the present invention. The realtime, transparent commodity index and trading database can be implemented as a computerized method or as an information processing system. Further, although the utilization of a diamond database DB is described extensively herein, the theories and the application of the realtime transparent commodity index, the formation and production of sub-indexes, and the operational aspects of the trading database can be applied to other commodities as long as those commodities are sold in units and each unit is graded by common set of characteristics. Diamonds are a widely traded commodity and are graded by color, cut, carat (weight) and clarity (the cccc). Similar numerals designate similar items throughout the drawings.

FIG. 1 shows input functions 10, processing functions 12 and output functions 13. These functions interact with diamond database 14 and some of these functions interact with contact or member Mbr database 16 listing all member sellers and buyers. The particular details of diamond database 14 are discussed later but, in general, the diamond database consists of a large plurality of diamond records red representing currently available stones for sale from manufacturers and producers of cut and polished diamonds. The data is available in realtime to buyer and seller members to facilitate sales. The diamond database lists common characteristics (cccc) for each diamond available for sale. The database is updated on a periodic trading basis explained later herein. Contact database 16 for buyer and seller member data lists name, address, company, email, phone number and fax number and location of each buyer and seller permitted to access and view the trading database and indexes. These databases are fully transparent and accessible to all buyer and seller members subject to password control. To initially build the diamond database, seller input function 18 involves the input of diamond records on a periodic trading basis into diamond database 14. A term “periodic trading basis” means the input or uploading of data into diamond database 14 on a periodic basis which is customary to the trading cycle of the diamond or commodity. In other words, if the trading cycle is typically a twenty-four hour cycle, a daily update or upload from a plurality of sellers (manufacturers or producers of cut and polished stones) into diamond database 14 is reasonable and necessary to maintain a realtime information pool for the commodity currently available for sale. However, if the trading time or cycle is customarily several four hour periods during each business day, then the data should be uploaded on a periodic trading basis every four hours. Basic common characteristics of each stone include weight in carats, cut, color, clarity and the asking price or offer price to sell that particular diamond and seller data. Diamond database 14 may include many entries or records for diamonds that have the same common characteristics. Those diamonds may be sold by the same seller or may be sold by a plurality of sellers at the same price or at different prices. This data is listed and is available to buyer and seller members. As is known in the diamond trade, each common characteristic is a range such that a −½ carat stone is a 0.45-0.49 ct stone and a ¾ carat stone is a 0.70-0.89 ct stone.

Function 20 recognizes that seller contact data is loaded into member database 16. Function 22 recognizes that buyer contact data is entered into member database 16. Function 23 represents a request from a buyer or a seller for buyer or seller contact data. This request is presented to a search engine 24 and the search engine interacts with member database Mbr DB 16 such that output 25 represents fully transparent contact data presented to the requesting party.

Input function 26 is a communication request from member 1 (either a buyer or a seller) and this communication request, in the preferred embodiment, is submitted to an instant messenger service communications function 28. The output from instant message service 28 is a communication to member 2 at output 27. The instant messenger IM service lists all the members logged into the trading database and permits one member to electronically communicate to another substantially instantaneously via an email function and have that second member communicate, on a substantially instantaneous basis, to the first member. The IM email communication is shown as a scrolled document to both parties. Other email or electronic communications may be used including voice, voice prints, voice recognition to text, voice over Internet, electronic fax, etc.

Input function 30 accepts a seller's search request to search diamond database 14 for one or more diamond listings. Search engine 32 conducts a search through the diamond database 14 and outputs a diamond list or D list as output function 31A or outputs realtime market advance inventory data packet as output 31B. Another words, a seller with an appropriate search request at input function 30 can data mine the diamond database as well as the composite index and the sub-indexes in order to provide an advance inventory function. The data for this advance inventory function can be integrated into the seller's inventory control system in order to educate the seller as to when to sell or release more diamonds of a certain grade (common characteristic) into the market or restrict the flow of available diamonds of a certain grade into the market. The advance inventory data acquisition function can also be used to set the current asking or selling price and to predict future prices and supply.

Input function 34 represents a buyer seeking to search diamond database 14. Search engine 36 conducts a search through diamond database 14 and outputs a diamond list as output 35. Function 38 represents a request which is input into the system for market data. This request may be from any buyer or seller. Access to the databases is based upon password control. The “request” may be a selection of a “market data” tab or object link on a web page of a server. The preferred ASP or web based server model incorporates many active web pages that accept user instructions and data which instructions and data are later processed by the server. The search request is presented to diamond database 14. As discussed later, the system prior to each trading period processes the representative diamond data in diamond database 14 and extracts certain information from certain segments of the database and certain diamond or stone profiles from those segments which are predictive of the price movement of the particular segment and the price movement of the diamond market as a whole, that is, a composite market. Output 39A is a diamond composite index and output 39B is the drivers or sub-indexes for the composite index. Diamond drivers are sometimes identified herein as sub-indexes and these sub-indexes are predictive of price and price movement in the index.

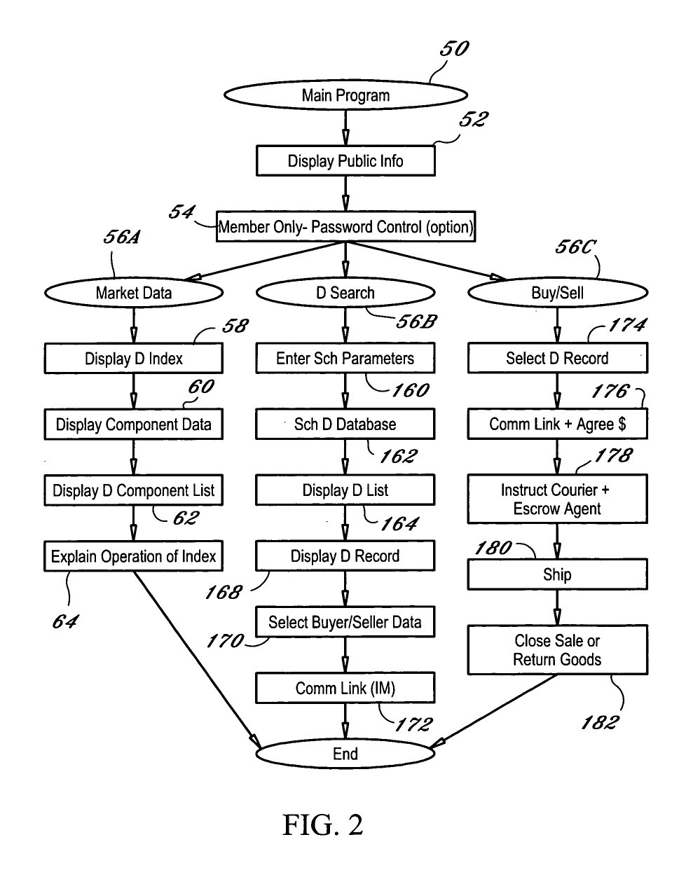

FIG. 2 diagrammatically shows a flowchart with several primary functional aspects of main program 50 implemented as a computerized method and an information processing system. Step 52 shows that the system displays certain public information. This public information may consist of news relative to the worldwide diamond industry, and specific news regarding sellers or buyers which affects the diamond market. Step 54 indicates that buyers and sellers are registered with the information system and assigned a password. Password control permits the developer of the composite index to be financially renumerated for the information services and limits access to the information to those who provide full details about themselves. Password control may be optionally applied to certain functions, for example full database access and member contract data, and not applied to others, for example, composite intex and market trend data. From password control 54, the system executes either the market data module 56A, the diamond search module 56B or buy/sell module 56C. The Banner Select Table shown below outlines selectable objects leading to other web pages on a web site maintained by a server. Other presentations or data selection input routines or modules may be used.

Banner Selection Table

Diamonds
Home page
Buy Diamonds (trading floor)
Sell Diamonds (trading floor)
Update Supply and Demand Records
Inspection List (similar to shopping cart)
Jewelry
Jewelry Home Page
Search (members/non-members)
Create your own showroom
Real Prices
Prices Home Page
Market Report
News
Current
Archives
Forums
Ads
Guest book
Community
Diamond Talk (IM) (comm link)
Members directory (Mbr contact DB)
Ads
Affiliates
Resource Links
Services
Help
Calendar
Currency Converter
World Time
email (comm link)
Administration
Password (My IDEX) (password control page)
Account data (personal contact data for Mbr)

The market data module 56A executes step 58 which displays the diamond composite index. Step 60 displays the component data or sub-indexes which are encompassed by the composite index displayed to the buyer or seller in step 58. Step 62 displays the lists of stone profiles which make up the plurality of sub-indexes or component indexes shown in step 60. Step 64 explains the operation of the index. Steps 58, 60, 62 and 64, show the buyer or seller how the composite index is created, what are the components or sub-indexes of that composite index, how the stone profiles are utilized to create the composite index, how the sub-indexes are created and displayed, and also see the historic price trends of both the composite index and all the diamond drivers or sub-indexes. This transparency, when coupled with realtime updates of diamonds available for sale, the diamond record, and the name, address, and background data for each seller and each buyer creates a realtime, transparent, commodity index and trading database that is different and unique to commercial commodity trading floors. Effectively, the inventive system is a transparent trading floor for diamonds.

The diamond database 14 retains data that describes each diamond available for sale based upon its common characteristics. These common characteristics are established in the diamond trade or commodity. The common characteristics for the diamond database and each diamond record in the diamond database are set forth below in the Color Table, Certification Table, Shape or Cut Table, Clarity Table, Price Per Carat (ppc) Table, the Carat or Weight Table and the Make Table. Notations listing “more” represent additional characteristics that are not listed herein.

Color Table
All (group selection), D, E, F, G, H, I, J, K, L, M, N, O, P,
White, Tlc, Cape, Brown, Fancy, More
Certification (CERT) Table
None
Any
GIA
EGL
AGS
IGI
HRD
More
Shape (cut) Table
Round
All fancy
Marquise
Emerald
Heart
Pear
Princess
Oval
More
Clarity Table
IF, VVSI, VVS2, VS1, VS2,
SI1, SI2, SI3, I1, I2, I3
$Price Per Carat (ppc) Table
All (group)
10
50
100 (more increments of $50)
Carat (Weight) Table
1/400
1/200
1/100
1/70
1/50 (more 1/10 increments)
⅙
⅕
¼
⅓
⅜
−½ (group range)
+½ (group)
¾
0.9
4/4
1.50 (more 0.5 increments)
Make Table
All (group)
Ideal
Excellent
Very Good
Good
Fair
Poor

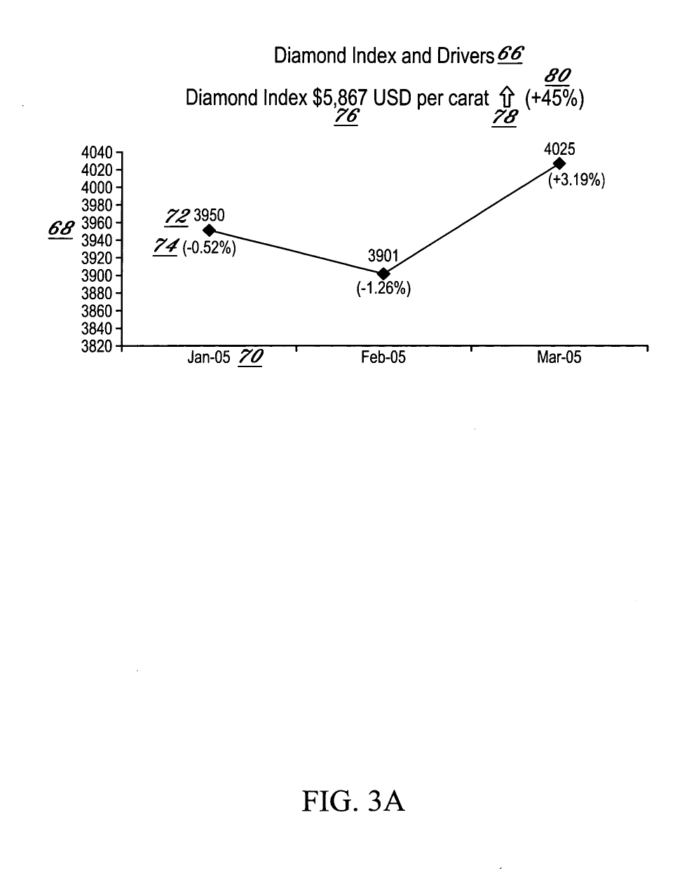

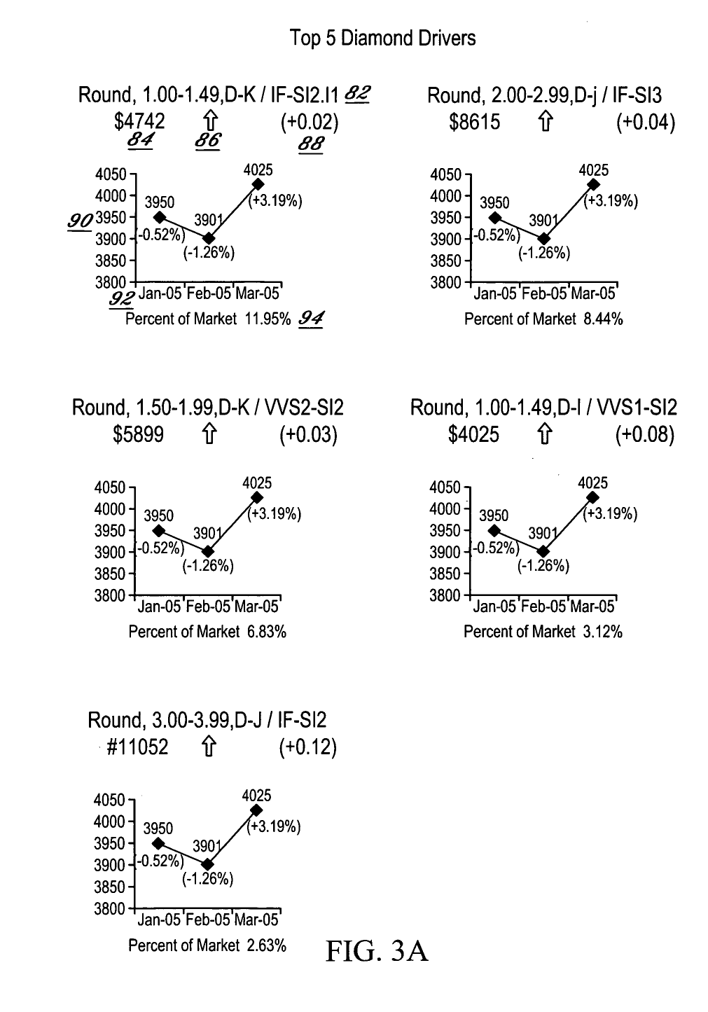

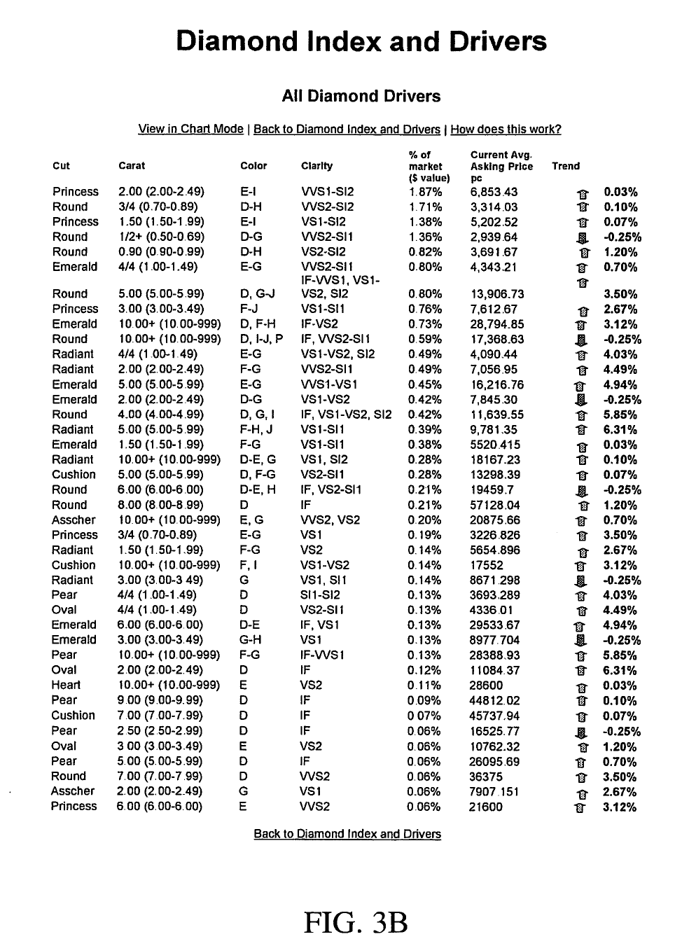

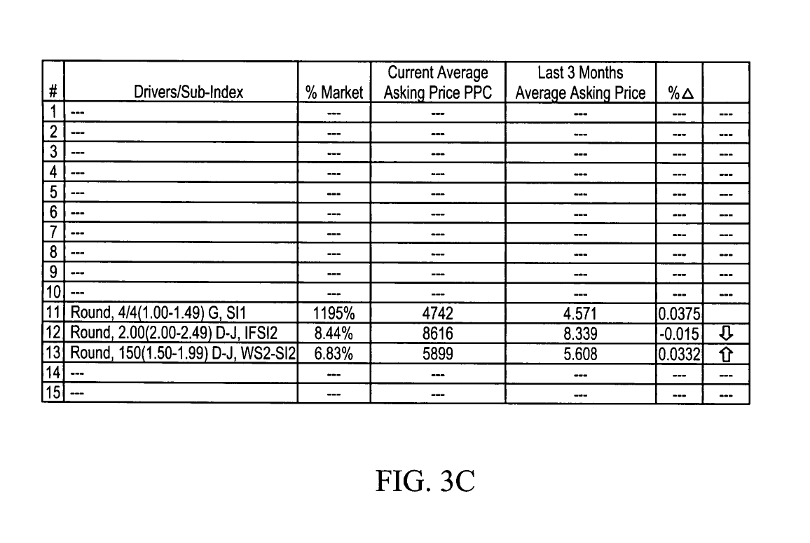

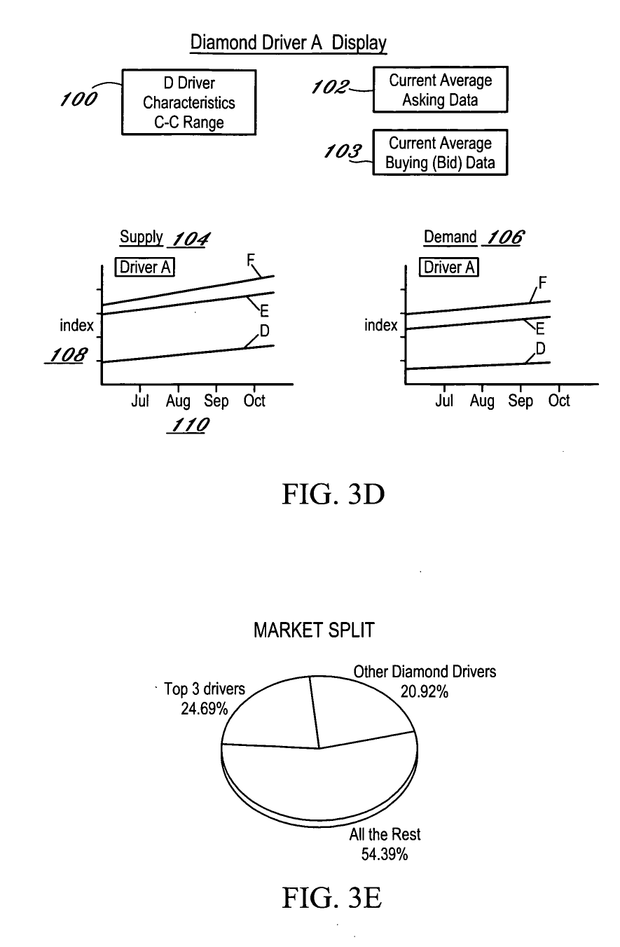

FIGS. 3A-3D show displays which are, in some form or format, presented by the computerized method or information processing system to the buyer or seller. FIGS. 3A-3D are examples of the transparent indexes and buy-sell data. The diamond composite index 66 lists a metric at region 68 which is, in one embodiment, the current value of the composite index. The original value of the index was assigned a 100 value but the index has increased since that time. Currently, 1 index point represents a 1% change. The time frame or historic time metric is shown in region 70 as the monthly periods of January, February, March of 2005. The index value originally set at 100 when the database was first created, is shown at 4025 and the index value is displayed at the end of each month in area 72 next to the data point as well as the percentage change from the close of the prior month at region 74. The composite index, in the preferred embodiment, also shows the current price per carat 76 (a price per unit), a trend indicator such as an up arrow or down arrow at region 78, and a percent change indicator at region 80. The percent change indicator is the percent change from the last composite data point calculated by the system which would be the last trading day of the previous month. Alternatively, the last trade period value may be shown. In a 24 hour trade period, the index metric is the composite value at the close of the previous trading day. The display shown in FIG. 3A also shows the top five diamond drivers or top five sub-indexes which are encompassed by the composite index shown at region 66. Since the information for all the diamond drivers or sub-indexes is of the substantially same type, only the sub-index at region 82 is discussed in detail herein.

The sub-index display at region 82 shows the stone profile of a round cut stone, having a carat weight range 1.00-1.49 and a color range D-K and a clarity range IF-SI2, I1. This data represents the common set of characteristics for predetermined stone profiles for the sub-index, which profiles are used to build or create the sub-index. In region 84 the sub-index price per carat ppc value is indicated. Other metrics may be used. In region 86 a trend indicator (up or down arrow) is shown. In region 88, the percent change from the previous trade day is shown. The historical chart shows in region 90 an index value range for the sub-index metric originally set at 100 when the database went active. Region 92 shows the historic time period and the graph shows data points which are displayed graphically in the interior of the graph formed by regions 90, 92. Region 94 shows the percent of the market represented by the particular diamond driver or sub-index listed in region 82. In other words, these diamond records or stones which fall in within this common set of common characteristics (round, 1.00-1.49, D-K, IF-SI2, I1) account for 7.9% of the market of the currently available stones from the entire database. The stones which fall in within this common set of common characteristics or stone profiles are statistically evaluated based upon a weighted average comparing each stone profile within the common set to the entire database and compiling a statistically relevant sub-plurality of stone profiles in the designated segment or sub-index. In other words, all round stones having these common set of characteristics in FIG. 3A, region 82, are counted as a quantity (frequency analysis) and the total dollar value of each of those diamond records is accumulated. The total quantity of all stones in the diamond database 14 (the stones currently available for sale) is computed based upon the number of diamond records and the total value of all the stone listed in the diamond database. The statistical relationship of the sub-index or the stone profiles to the total diamond database is shown in region 94. Of course, if one or more sellers decides not to supply the market with these types of stones (stones within that common set stone profile indicated in region 18), the weighted average of the stones fitting the stone profile decreases and the statistical importance of this sub-index or diamond driver to the overall market decreases. This statistical relationship information is helpful to the buyer or seller for two reasons. First, it provides the seller an indication of the importance of this diamond driver or sub-index to the overall composite diamond index. Second, it provides indication to the buyer or seller of the current asking price (offer price) for stones falling within (or near) the common set of stone profiles. Historic trend indicators over predetermined periods of time, whether daily, weekly, monthly, quarterly, yearly or longer, provide additional information to the buyer and seller of these commodities. To create the composite index shown in region 66, each stone profile is compiled and assigned the statistically relevant relationship of its weighted average. Other statistical algorithms, other than a weighted average function, may be utilized as long as the sub-index and its constituent components are statistically relevant to the price and price trend of the commodity market as a whole.

In order to provide additional information to the buyer or seller of stones, each sub-index may be coupled to a further Trend Table display shown below. The buyers must input bid or buy price data for a particular stone to fill some of the elements of this Trend Table.

Diamond Driver (Sub-Index) Trend Table

```
Round
4/4 (1.00-1.49)
G
SI1
Very Good, Good, GIA
Current average asking price per carat (“PPC”)
                    High   ppc
                    Low   ppc
            last 5 months aver. ask   ppc
                percent of mkt.   %
Current average buying price   ppc
              high   ppc
              low   ppc
      last 6 months aver. ask   ppc
          percent of mkt   %
```

FIG. 3B is another example of a display which may be presented to the buyer or seller utilizing the computerized method and information processing system. FIG. 3B shows an example of various stone profiles which may be grouped into a certain sub-index or diamond driver. Therefore, in a system employing the display in FIG. 3B, the princess stone is a certain stone profile having an assigned or general carat weight of 2.0 but representing a carat range 2.0-2.49. The color range is E-I. The clarity range is VVS1-SI2. The percent of market value of that stone profile is 1.87%. Another words, based upon the number of records in the diamond database and the total value of those records for stones fitting that stone profile, the impact of that stone profile on the overall market is 1.87%. The current asking price ppc and a trend indicator and a percent change from the previous trading day is shown.

In another embodiment, FIG. 3C shows an exemplary list of diamond drivers (sub-indexes) which lists all sub-indexes. As discussed later, each diamond driver utilizes, in one embodiment, a number of statistically significant stone profiles. Sub-index 11 shows round stones having a common set of characteristics within the range designated 4/4 having a carat weight 1.00-1.49 and a G color value and a SI1 clarity value. This round stone 4/4 driver accounts for 11.95% of the total market. The diamond driver or sub-index list shows the average asking price per carat, the average price averaged over the last three months, the percent change from the previous day and an indicator symbol from the previous day figures for each driver. Other formats for the diamond drivers may be used provided that the buyer or seller has access to the underlying data. By selecting one sub-index or driver on the display in FIG. 3C, the user views the following table listing constituent stone profiles within the driver.

Driver (Sub-Index) Constituent Table
Sub-Index Common Set Characteristic Ranges
Statistical weight or relevance factor

| Cut | Carat | Color | Clarity | % of Driver |
|---|---|---|---|---|
| round | xx − yy | r | z | pp % |
| round | x1x1 − y2y2 | r + 1 | z + 1 | pp1% |
| round | x2x2 − y3y3 | r − 2 | z + 2 | pp2% |

FIG. 3D shows a Diamond Driver A display which may be displayed to the buyer or seller of stones utilizing the current method. This display includes region 100, the diamond driver or sub-index characteristics (see Driver A Trend Table below) and the set of common characteristics of the diamond such as carat, cut, clarity and color. Region 102 shows the average asking price data and region 103 shows the average buying or bid price data in the following Table as it relates to FIG. 3D.

Diamond Driver A Trend Table

```
Region 100:
Round
4/4 (1.00-1.49)
G
SI1
Very Good, Good, GIA
Region 102:
Current average asking price per carat (“PPC”)
                    High   ppc
                    Low   ppc
            last 5 months aver. ask   ppc
                percent of mkt.   %
Region 103:
Current average buying price   ppc
              high   ppc
              low   ppc
      last 6 months aver. ask   ppc
          percent of mkt   %
```

In addition, FIG. 3D shows a supply graph at region 104 and a demand graph at region 106. The supply and demand graphs are shown for a particular driver (sub-index) and the index value is shown in region 108 and the time frame for that historic trend is shown in region 110. Demand graphs require bid data to be input into the diamond database by buyers. Graph lines D, E and F relate to various colors or other common characteristic that might differentiate certain stones within a particular common set of common characteristics, that is, certain stones which fall in with a predetermined stone profile which encompasses the sub-index. The stone profile range is shown in region 100. The demand curve in region 106 shows buying or bid data rather than selling or asking price data. With the concurrent display of the common set of stone profiles which comprise the sub-index, the buyer or seller can validate and ascertain the scope and importance of the sub-index.

In order to determine statistically significant aspects of the diamond base, data from a large number of manufacturers which sell cut and polished stones was collected for over a one year period of time. Some wholesaler data is also included. This data represents stones made available for sale from approximately 50% of all manufacturers on a worldwide basis. It is estimated that the diamond database during this one year period represented between 70-75% of all diamond sale data (diamonds for sale) based upon dollar volume. In the diamond industry, about 20 companies conduct about 80% of all the world trade based upon dollar volume. In operation, the present invention utilizes supplier information from about 30 companies. Manufacturer's data is uploaded via complementary computer programs linking database 14 to the seller's inventory database, ASP input modules or excel spreadsheet import/export routines. It is estimated that approximately 30-40% of all diamonds traded on a worldwide basis are represented in the diamond database 14 in the present invention. This represents about 45% of all goods sold based upon dollar volume. The integrity of the information from diamond database 14 is based upon the information provided by the sellers or diamonds. If the sellers of diamonds limit or restrict data or otherwise inaccurately report diamond data, this adversely affects the integrity of the diamond database and the composite index and the predictability of the index and sub-indexes. To create the drivers or sub-indexes, the diamond database, after being compiled for this one year period, was analyzed to locate and identify statistically significant stone profiles based upon (a) frequency in the database and (b) monetary value ratios. Fifteen segments consisting of groups of stone profiles were established principally based upon cut and carat values. The fifteen segments were selected as being leading market indicators based upon the quantity of stones in the diamond database and the total value of those stones (economic or trading value analysis). Since each stone or diamond record in the diamond database is identified by lot number or supplier number, when that stone (or packet of stones if listed as a packet) is offered for sale, the data is captured and processed by the diamond database. The daily update from sellers deletes records fo sold diamonds. If the seller replaces a sold packet with a new packet having the same characteristics, the new data for the new packet statistically replaces old data and the old data for the sold packet is deleted. If the supplier does not replace the diamond record, the old data is no longer present in the database. The fifteen leading market segments were selected based upon the quantity of diamond records in the diamond database (each stone profile was always represented by product in the database during the one year period) as well as the total value of those segments in relationship to the entire diamond database. Statistical analysis confirmed that the information extracted from 300 stone profiles was representative of the price and the price movement of the diamonds in the entire diamond database and in the corresponding segment or sub-index encompassing the profiles.

The 300 leading stone profiles are selected based upon frequency of occurrence and cumulative dollar value. Different segments have different numbers or sub pluralities of stone profiles but all profiles are statistically relevant to the composite index and the corresponding sub-index. These sub-indexes are sometimes called “diamond drivers” herein. The 300 stone profiles spread over 15 leading market segments account for approximately 43% of the total diamond market in value. Price movements of these 300 stone profiles were shown to be statistically significant predictors of (a) the entire market represented by the diamonds available for sale in database 14 and (b) the respective segment which encompasses the stone profile. In one working embodiment, statistical significance is based upon the frequency and cumulative monetary value (a weighted average). Further, data compiled for a particular stone profile is fully reported or displayed to the buyer or seller. The weighted average of each segment (compiled by its constituent stone profiles), is also calculated and displayed with the sub-index value to the buyer or seller. Other algorithms maybe used to establish the statistical significance of a group of records to predetermined segments or sub-indexes and to the entire database or composite index. Statistical relevance to a key economic indicator, for example a stone profile or group of profiles compared to a published economic indicator (for example, the inflation rate based upon the consumer price index) maybe used provided that the data establishing the statistical relevance is published or displayed with the index.

Diamond database 14 only shows stones available for sale. As discussed later, the buyer and seller can locate a particular stone, identify the seller, and identify all characteristics associated with that stone and the seller substantially simultaneously. If a pair of stones is being sold as a unit (a matching pair of diamonds), that pair unit is indicated as a single diamond record. If a parcel of stones is being sold by a seller as a single unit, the characteristics of that parcel unit are indicated as a single diamond record. In order to compute the current deposit index, the total value of all stone profiles is computed. The driver or sub-indexes are calculated as weighted average of all predetermined stone profiles in a particular segment. Each diamond driver or sub-index is calculated and displayed as a current index in points, the change in percentage with reference to the prior day's closing and the current asking price per carat ppc is calculated as the weighted average of the constituent diamond stone profiles. In other words, referring to the Diamond Driver A FIG. 3C, the stone profile 11 is given a higher weight or statistical relevance in calculating the diamond driver or sub-index A as compared with stone profile 13 because the stone profile 11 has 11.95% of the market of that segment or driver as compared with stone profile 13 which only has 6.83% of the segment or driver.

FIG. 3E shows a pie chart with the top three diamond drivers or sub-indexes representing approximately 25% of the total diamond market and all other diamond drivers accounting for approximately 21%. Therefore, these diamond drivers or sub-indexes account for approximately 46% of the entire diamond trade represented by database 14. One important aspect of the present invention is that all this information is made available to the buyer and seller such that the buyer and seller can make his or her own determination as to the relevance and importance of these sub-indexes and the general commodity index.

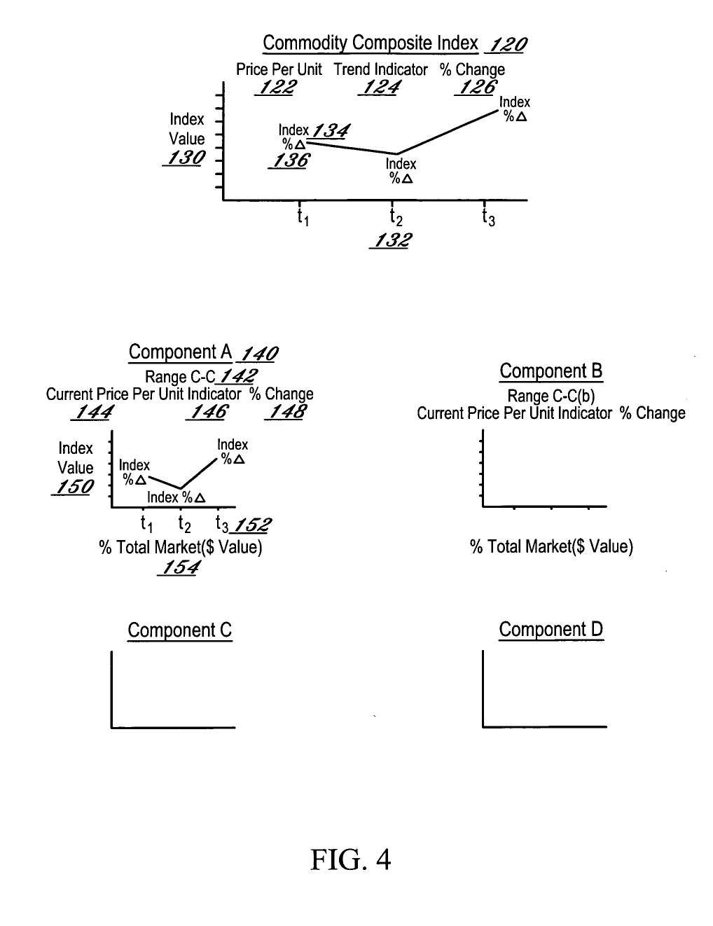

FIG. 4 diagrammatically illustrates that the principles of the present invention can be extended into any commodity that is sold in units wherein each unit can be graded by a set of common characteristics. The schematically illustrated display in FIG. 4 shows a composite index in region 120. Region 122 shows the price per unit ppu of the commodity being sold. Region 124 indicates the trend from the previous trading day and region 126 shows the percent change from the previous trading day. The chart below the composite index 120 shows an index value in region 130, a time line in region 132 and the historic index value in region 134 at time t1 as well as the percentage change in price from the previous indicated trading period in region 136. Immediately below composite index 120 are sub-indexes or components in region 138. Sub-index or component A is shown in region 140. The particular details or common characteristics (the common set of common characteristics) is shown in region 142. Also below the listing of common characteristics for the units forming the component A is the current price per unit in region 144, a trend indicator in region 146 and a percent change in region 148, that percent change relating to the last and the current trading day. The chart shows sub-index value in region 150 and shows the time frame at region 152. The index value (“ind”) and change from previous time frame is shown in association with each data point on the chart. Further in region 154, an indication is provided as to the statistical significance of component A in the overall operation of the total database for the commodity. Therefore, the statistical weight or relationship factor is an important piece of information to the buyer or seller because the higher the weight or value factor, the greater the impact of the price movement of that sub-index on the overall composite index. Other graphs related to components B, C, D (relative to sub-indexes B, C, D) are only schematically illustrated in FIG. 4.

Returning to FIG. 2, the buyer or seller may elect to conduct a diamond search through the diamond database 14 in step 56B. One example of available search parameters and a selectable input screen presented by the web server to the buyer or seller is set forth below.

Search Screen

| | | | |
|---|---|---|---|
| Cut | | Make | from to |
| Carat | from to | Price/ct | from to |
| | Manual input to | Certificate | |
| Color | from to | Supplier | |
| Clarity | from to | Location | |

The buyers are presented with the Buyer Supplemental Selection table immediately below and the sellers are presented with a Seller Supplemental Selection table as set forth below.

Buyers Supplemental Selection
Singles parcels pairs sets
Sellers Supplemental Selection
Show new Show all

The user (either a buyer or seller) can select search parameters from the search screen (see above) typically via pull down menus. For example, the “cut” search criteria is found in a pull down menu and an example of some of the cuts or shapes of the stone in the database are listed earlier in the “Shape (Cut) Table.” The carat selection is also a pull down table and this is presented earlier is the Carat (weight) Table. Optionally, the user can manually input minimum and maximum carat values. Step 160 notes that the user has entered search parameters. Step 162 conducts a search of the diamond records through diamond database 14. A search engines 32, 36 maybe utilized. Step 164 displays a list of diamonds (D List) which fall within the parameters of the search as a D list.

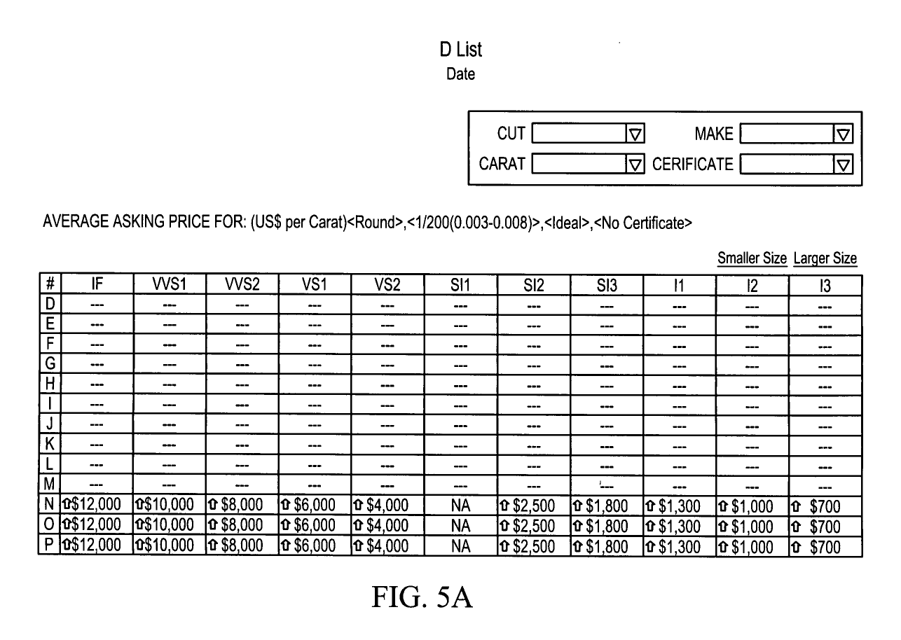

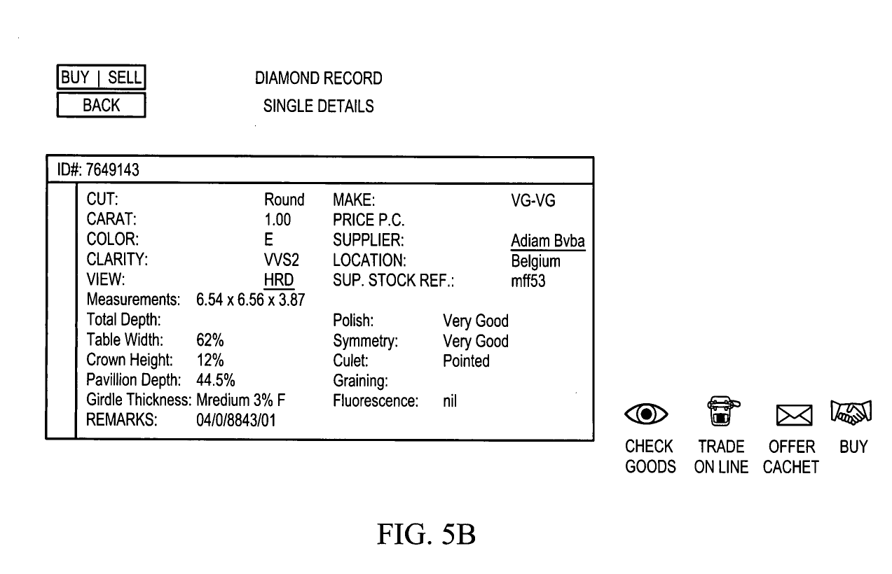

FIG. 5A shows a portion of a diamond D list. It is common for the diamond list to show color along one axis of the table and clarity along another axis of the table. The scope of the search shown in FIG. 5A is “round, less than 1/200 carats (0.003-0.008) with an ideal cut with no certificate” by a certifying authority. Further, the average asking price in dollars per carat is presented to the user. Trend indicators for each data point is shown. In other words, an N color stone having a clarity VS1 is priced at $6,000.00 per carat and the trend indicator indicates that the price has risen from the previous day's trading information. The list in FIG. 5A shows a compilation of data from related diamond records in the database.

Returning to FIG. 2, step 168 displays the diamond d record for a particular stone selected by a user. FIG. 5B shows the diamond record for a single stone. This diamond record includes, along with the common characteristics for the stone, the name and location of the supplier or seller as well as the supplier's stock reference. Other formats may be used to display the record. These are output screens by the web server. Further, in order to facilitate communications for the trading database, the user can select “buy” or select a communications routine that will place the seller and the buyer in an instant messaging communications function or other communications module.

Returning to FIG. 2, step 170 permits the user to select the buyer or seller contact data. Step 172 establishes a communication link between the buyer and seller. This communication link, includes, in one embodiment, an instant messaging IM service and may also include an email facility such that the potential buyer could compose an email to be sent to the seller via a normal email communications channel. The implementation of a phone dialing service as a communications link and the use of a hyperlink from the diamond database website to the supplier's website is also contemplated by this communications link step 172.

Rather than activating the market data sub-routine 56A, or the diamond search sub-routine 56B, the user may also select the buy/sell routine 56C. In this situation, in step 174, the buyer selects a diamond record. In step 176, the buyer and/or the seller activates a communications link. The buyer and seller then establishes a price for the purchase of the diamonds offered for sale in the diamond database 14. In step 178, the system communicates and interacts with a courier to deliver the goods to the buyer from the seller and also contacts and facilitates the transaction with a financial escrow agent. The utilization of a financial escrow agent ensures that the goods, once delivered from the seller to the buyer, are ultimately paid for by the buyer. Step 180 indicates that the goods have been shipped and step 182 indicates that the sale of goods has been made or the goods have been returned to the seller. The buy/sell routine may be expanded to include bid data from the buyer of a stone.

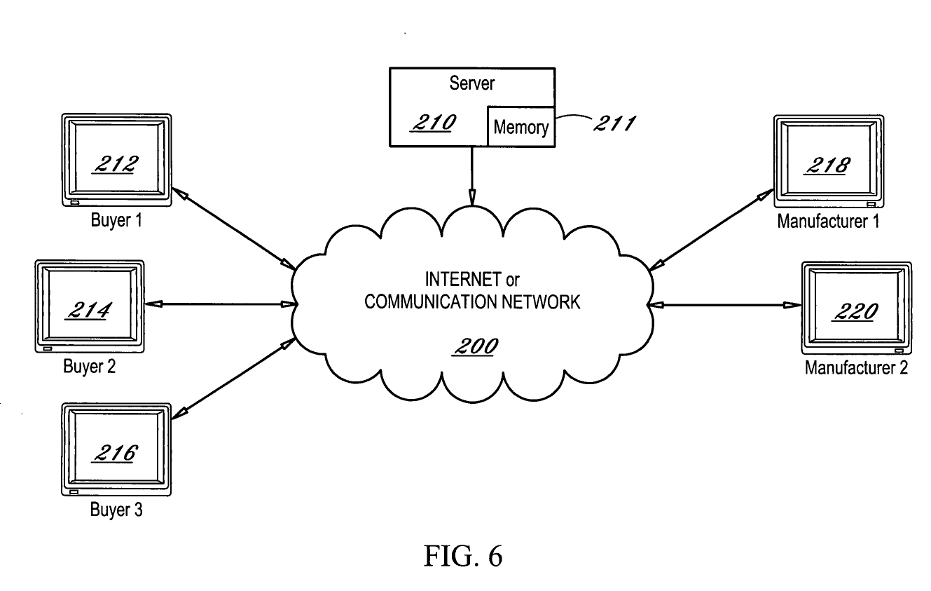

FIG. 6 diagrammatically illustrates the overall communications of hardware system for the present invention. Internet or other communications network 200 links a server computer 210 having memory 211 to the Internet. Further, buyer 1, buyer 2, and buyer 3 have client computers 212, 214 and 216. Manufacturers 1 and 2 have client computers 218, 220. Client computers 212-220 communicate with server 210 via Internet or communications network 200 to download information, request information regarding diamonds, diamonds records, composite index, sub-indexes, and the contact data. It should be noted that rather than a wired network, such as the Internet, a mobile communications network may be merged with the wired network, LAN, WAN, Internet or telecommunications link. The input and output displays may be configured to display information on a cell phone screen or a personal electronic device (PAD, Blackberry, etc.). The user input functions may be altered to accommodate the use of these mobile communications devices.

As is known, the instant messaging IM service lists all registered users currently on line. The buyer or seller may select the following control elements from the displayed web page.

Option Controls

Send email
Waiting messages
Help
My contacts
Member information (highlight on line member and
show contact and profile data)
Write message

The claims appended hereto are meant to cover modifications and changes within the scope and spirit of the present invention.

What is claimed is:

1. A computerized method of creating and displaying realtime indexes and a trading database for diamonds for a buyer or a seller comprising:
maintaining on a periodic trading basis, and displaying upon command, a computerized database representing diamonds available for sale and common characteristics thereof including respective offer prices to sell said diamonds;
processing data from a plurality of predetermined statistically significant segments of the diamond database, each segment represented by a plurality of predetermined stone profiles in the database segment and each stone profile having a common set of common characteristics, the statistical significance based upon the respective quantity of diamond records in said database and the respective monetary value;
determining and displaying a plurality of sub-indexes, each sub-index based upon data from respective predetermined stone profiles in a corresponding segment, said respective stone profiles being statistically significant relative to said corresponding segment; and,
determining and displaying a composite index based upon said plurality of stone profiles.

2. A computerized method for producing realtime indexes and a trading database as claimed in claim 1 wherein a plurality of sellers and buyers access said diamond database and the method includes maintaining contact data relative to sellers of said diamonds available for sale and the method includes facilitating a communications session between said buyer and a respective seller of said diamonds available for sale.

3. A computerized method for producing realtime indexes and a trading database as claimed in claim 2 including linking each diamond record in said diamond database with contact data for said respective seller to facilitate said communications session.

4. A computerized method for producing realtime indexes and a trading database as claimed in claim 3 including providing an instant messenger service for said buyers and sellers.

5. A computerized method for producing realtime indexes and a trading database as claimed in claim 3 including maintaining contact data for all buyers and, subject to a password control available to all buyers and all sellers, all buyers and all sellers access the display of said diamond database and contact data.

6. A computerized method for producing realtime indexes and a trading database as claimed in claim 4 including maintaining contact data for all buyers and, subject to a password control available to all buyers and all sellers, all buyers and all sellers access the display of said diamond database and contact data.

7. A computerized method for producing realtime indexes and a trading database as claimed in claim 1 wherein the acts of displaying include web-based displays of data and include selecting objects from said web-based display.

8. A computerized method for producing realtime indexes and a trading database as claimed in claim 1 including determining and displaying trends of said composite index and each said sub-index, said trends indicating historic data over predetermined periods of time.

9. A computerized method for producing realtime indexes and a trading database as claimed in claim 1 wherein determining said composite index includes modifying each stone profile of said plurality of stone profiles based upon its relationship to the entire diamond database, the respective quantity of diamond records and respective monetary value.

10. A computerized method for producing realtime indexes and a trading database as claimed in claim 1 including displaying said predetermined stone profiles for corresponding segments.

11. A computerized method for producing realtime indexes and a trading database as claimed in claim 10 wherein displaying said predetermined stone profiles includes displaying data indicative of the respective common set of common characteristics, said common characteristics including carat weight, color, clarity and cut and price per carat for each diamond represented by each diamond record.

12. A computerized method for producing realtime indexes and a trading database as claimed in claim 1 including data mining said diamond database and said composite index and said sub-indexes and integrating the resultant data into an inventory control system for a unique seller.

13. A computerized method for producing realtime indexes and a trading database as claimed in claim 1 wherein a plurality of sellers and buyers access said diamond database and the method includes facilitating sales of diamonds represented in said diamond database by electronically linking a financial escrow agent and a diamond courier with a willing buyer and seller of a selected diamond from said diamond database.

14. A computerized method for producing realtime indexes and a trading database as claimed in claim 6 wherein the acts of displaying include web-based displays of data and include selecting objects from said web-based display.

15. A computerized method for producing realtime indexes and a trading database as claimed in claim 14 including determining and displaying trends of said composite index and each said sub-index, said trends indicating historic data over predetermined periods of time.

16. A computerized method for producing realtime indexes and a trading database as claimed in claim 15 wherein determining said composite index includes modifying each stone profile of said plurality of stone profiles based upon its relationship to the entire diamond database, the respective quantity of diamond records and respective monetary value.

17. A computerized method for producing realtime indexes and a trading database as claimed in claim 16 including displaying said predetermined stone profiles for said corresponding segment and includes displaying data indicative of the respective common set of common characteristics, said common characteristics including carat weight, color, clarity and cut and price per carat for each diamond represented by each diamond record.

18. A computerized method for producing realtime indexes and a trading database as claimed in claim 17 including data mining said diamond database and said composite index and said sub-indexes and integrating the resultant data into an inventory control system for a unique seller.

19. A computerized method for producing realtime indexes and a trading database as claimed in claim 18 wherein a plurality of sellers and buyers access said diamond database and the method includes facilitating sales of diamonds represented in said diamond database by electronically linking a financial escrow agent and a diamond courier with a willing buyer and seller of a selected diamond from said diamond database.

20. An information processing system creating and displaying realtime indexes and a trading database for diamonds for a plurality of buyers and sellers of diamonds comprising:
a database having data representing diamonds available for sale and common characteristics thereof including respective offer prices to sell said diamonds;
a communications link uploading, on a periodic trading basis, said data representing diamonds into said diamond database; and,
a processor for determining a composite index and for determining a plurality of sub-indexes from a plurality of predetermined statistically significant segments of the diamond database, each segment represented by a plurality of predetermined stone profiles in the database segment and each stone profile having a common set of common characteristics, the statistical significance based upon the respective quantity of diamond records in said database and the respective monetary value;
means for displaying, upon command of said plurality of buyers and sellers, said diamond database and diamond records therein, said composite index and each of said plurality of sub-indexes.

21. An information processing system as claimed in claim 20 including a contact database for said plurality of sellers and buyers and a further communications link uploading the buyer and seller contact data into said contact database, said diamond database being linked to said contact database relative to each diamond record therein and a respective seller of said diamonds available for sale.

22. An information processing system as claimed in claim 21 including an instant messenger service for said buyers and sellers.

23. An information processing system as claimed in claim 22 including a server, as part of said means for displaying, to establish web-based displays of said diamond database, plurality of sub-indexes, composite index and contact data.

24. An information processing system as claimed in claim 20 including a server, as part of said means for displaying, to establish web-based displays of said diamond database, plurality of sub-indexes, composite index and contact data.

25. An information processing system as claimed in claim 20 wherein said processor determines historic trends of said composite index and each said sub-index over predetermined periods of time and said means for displaying displays such trends.

26. An information processing system as claimed in claim 20 wherein said processor determines said composite index by modifying each stone profile of said plurality of stone profiles based upon its relationship to the entire diamond database, the respective quantity of diamond records and respective monetary value.

27. An information processing system as claimed in claim 20 wherein said means for displaying displays said predetermined stone profiles for corresponding segments including carat weight, color, clarity and cut and price per carat for each diamond represented by each diamond record.

28. An information processing system as claimed in claim 20 wherein said plurality of sellers and buyers cooperate with a financial escrow agent and a diamond courier, said system including a supplemental communications link between a willing buyer and seller of a selected diamond from said diamond database, said financial escrow agent and said diamond courier.

29. An information processing system as claimed in claim 23 wherein said processor determines historic trends of said composite index and each said sub-index over predetermined periods of time and said means for displaying displays such trends.

30. An information processing system as claimed in claim 29 wherein said processor determines said composite index by modifying each stone profile of said plurality of stone profiles based upon its relationship to the entire diamond database, the respective quantity of diamond records and respective monetary value.

31. An information processing system as claimed in claim 30 wherein said means for displaying displays said predetermined stone profiles for corresponding segments including carat weight, color, clarity and cut and price per carat for each diamond represented by each diamond record.

32. An information processing system as claimed in claim 31 wherein said plurality of sellers and buyers cooperate with a financial escrow agent and a diamond courier, said system including a supplemental communications link between a willing buyer and seller of a selected diamond from said diamond database, said financial escrow agent and said diamond courier.

33. A computerized method of creating and displaying realtime indexes and a trading database for a commodity for plurality of buyers and sellers, said commodity having sold in units and each unit being graded by common characteristics comprising:
maintaining on a periodic trading basis, and displaying upon command, a computerized database representing units of said commodity available for sale and common characteristics thereof including respective offer prices to sell said units;
processing data from a plurality of predetermined statistically significant segments of the commodity database, each segment represented by a plurality of predetermined unit profiles in the database segment and each unit profile having a common set of common characteristics, the statistical significance based upon the respective quantity of unit records in said commodity database and the respective monetary value;
determining and displaying a plurality of sub-indexes, each sub-index based upon data from respective predetermined unit profiles in a corresponding segment, said respective unit profiles being statistically significant relative to said corresponding segment; and,
determining and displaying a composite index based upon plurality of predetermined unit profiles.

34. A computerized method for producing realtime indexes and a trading database as claimed in claim 33 wherein said plurality of sellers and buyers access said commodity database and the method includes maintaining contact data relative to sellers of said commodity available for sale and the method includes facilitating a communications session between said buyer and a respective seller of said unit of commodity available for sale.

35. A computerized method for producing realtime indexes and a trading database as claimed in claim 34 including linking each unit record in said commodity database with contact data for said respective seller to facilitate said communications session.

36. A computerized method for producing realtime indexes and a trading database as claimed in claim 35 including providing an instant messenger service for said buyers and sellers.

37. A computerized method for producing realtime indexes and a trading database as claimed in claim 35 including maintaining contact data for all buyers and, subject to a password control available to all buyers and all sellers, all buyers and all sellers access the display of said commodity database and contact data.

38. A computerized method for producing realtime indexes and a trading database as claimed in claim 36 including maintaining contact data for all buyers and, subject to a password control available to all buyers and all sellers, all buyers and all sellers see the display of said commodity database and contact data.

39. A computerized method for producing realtime indexes and a trading database as claimed in claim 33 wherein the acts of displaying include web-based displays of data and include selecting objects from said web-based display.

40. A computerized method for producing realtime indexes and a trading database as claimed in claim 33 including determining and displaying trends of said composite index and each said sub-index, said trends indicating historic data over predetermined periods of time.

41. A computerized method for producing realtime indexes and a trading database as claimed in claim 33 wherein determining said composite index includes modifying each predetermined unit profile of said plurality of unit profiles with a statistically significant algorithm based upon its relationship to the entire commodity database, the respective quantity of unit records and respective monetary value.

42. A computerized method for producing realtime indexes and a trading database as claimed in claim 33 including displaying said predetermined unit profiles for corresponding segments.

43. A computerized method for producing realtime indexes and a trading database as claimed in claim 42 wherein displaying said predetermined unit profiles includes displaying data indicative of the respective common set of common characteristics.

44. A computerized method for producing realtime indexes and a trading database as claimed in claim 33 including data mining said commodity database and said composite index and said sub-indexes and integrating the resultant data into an inventory control system for a unique seller.

45. A computerized method for producing realtime indexes and a trading database as claimed in claim 33 wherein a plurality of sellers and buyers access said commodity database and the method includes facilitating sales of units of said commodity represented in said commodity database by electronically linking a financial escrow agent and a courier with a willing buyer and seller of a selected unit from said commodity database.

46. A computerized method for producing realtime indexes and a trading database as claimed in claim 38 wherein the acts of displaying include web-based displays of data and include selecting objects from said web-based display.

47. A computerized method for producing realtime indexes and a trading database as claimed in claim 46 including determining and displaying trends of said composite index and each said sub-index, said trends indicating historic representative data over predetermined periods of time.

48. A computerized method for producing realtime indexes and a trading database as claimed in claim 47 wherein determining said composite index includes modifying each predetermined unit profile of said plurality of unit profiles with a statistically significant algorithm based upon its relationship to the entire commodity database, the respective quantity of unit records and respective monetary value.

49. A computerized method for producing realtime indexes and a trading database as claimed in claim 48 including displaying said predetermined unit profiles for said corresponding segment and includes displaying data indicative of the respective common set of common characteristics.

50. A computerized method for producing realtime indexes and a trading database as claimed in claim 49 including data mining said commodity database and said composite index and said sub-indexes and integrating the resultant data into an inventory control system for a unique seller.

51. A computerized method for producing realtime indexes and a trading database as claimed in claim 50 wherein a plurality of sellers and buyers access said commodity database and the method includes facilitating sales of units of commodity represented in said commodity database by electronically linking a financial escrow agent and a courier with a willing buyer and seller of a selected unit from said commodity database.
